(19) United States
(12) Patent Application Publication
(10) Pub. No.: US 2006/0090083 A1
(43) Pub. Date: Apr. 27, 2006

(54) Data protection system

(76) Inventor: Kwok-Yan Leung, Willowdale (CA)

Correspondence Address: LIN & ASSOCIATES INTELLECTUAL PROPERTY, P.O. BOX 2339, SARATOGA, CA, 95070-0339, US

(21) Appl. No.: 10/974,634

(22) Filed: Oct. 27, 2004

(51) Int. Cl. G06F 12/14; H04L 9/32; G06F 11/30

(52) U.S. Cl. 713/189; 713/193

(57) ABSTRACT

Disclosed is a data protection system, including a data processing device and a decryption element. The data processing device accesses protected data that have been processed by the protection code. The decryption code stores the releasing code corresponding to the protection code by means of the memory unit. When requiring to read the protected data, the protected data must first be converted back into the ordinary data through the decryption code provided by the decryption element.

### BACKGROUND OF THE INVENTION

1. Field of the Invention

The present invention relates to a data protection system, especially to the initialization device used in providing the protected data read from the data processing device using the key similar decryption element.

2. The Prior Arts

In general, the computer operating system makes use of the account code/password verification as the means for data protection. Though the account code/password of some operation system cannot be easily decrypted. However, for example, the hard disk drive of the data processing device, once removed from the computer, the data stored therein can easily be accessed by making use of another computer, not to mention the fact that the man-made account code/ password still has the possibility of being decrypted.

In order to tackle and overcome this problem, Taiwan Patent No. 187480 discloses a “computer data protection device”, which can be used to solve this problem. Briefly speaking, the technical means it utilizes lies in additionally setting up the “computer data protection device” between a main frame (or CPU of the computer) and a hard disk drive, and achieving the purpose of data protection by encrypting/decrypting the data during the reading/writing of data from/to the hard disk drive.

However, if an intended person removes the “computer data protection device” together with the hard disk drive from the computer, the person still be able to successively decrypt the data stored therein through the built-in decryption mechanism, and as such it is still not possible to achieve for certain the purpose of data protection.

The purpose of the technical contents disclosed by Taiwan Patent Publication No. 591630, which is entitled “the data protection device and the data encryption method of the storage medium”, is to overcome the problem of Taiwan Patent No. 187480 by means of the “password verification unit”. However, judging from the technology as disclosed in “the data protection device and the data encryption method of the storage medium”, though it can decide whether to allow the decryption mechanism to start proceeding with the data decryption procedure through first checking if the password is correct, as such to avoid the problem arising from the action that the protection device itself is removed together with the hard disk drive, and thus avoiding the resulting consequence that the purpose of data protection can not be achieved. However, the setting up of the man-made password still leads back to the problem that the man-made account code/password can be decrypted.

In addition, the CD disk can easily be removed from the CD drive of the data processing device, for example, the floppy disk drive, flash memory reader/writer, AIP disk drive JAZ disk drive, magnetic tape device, etc. All these data processing devices are more easily removed together with the storage medium used for storing data than the hard disk drive. Therefore, there exists an urgent need for an extremely safe data protection mechanism.

Besides, due to the rapid progress of the CD recording technology in recent years, which leads to the fact that the account code/password of the CD used for storing multi medium, games, and Utility, will eventually be decrypted regardless of the data protection means adopted. That means that the data protection means must achieve breakthrough, so as to successfully overcome the various problems mentioned above.

### SUMMARY OF THE INVENTION

An objective of the present invention is to provide a data protection system, which through reading the releasing code stored in the key similar device, so as to make the corresponding device proceed with the disabling of the data protection procedure, and to successively read out the data stored in the data processing unit.

Another objective of the present invention is to provide a data protection system, which through carrying out the decryption or scrambling protection operation in bytes, so that the protection data generated by this operation will not occupy too much storage space.

The present invention provides a data protection system, comprising data processing device and decryption element. The data processing device is used to access the protected data that have been processed by the protection code. The decryption element is used to store the releasing code corresponding to the protection code by means of the memory unit. When it is necessary to read the protected data, the protected data must first be converted to the ordinary data through the decryption code provided by the decryption element.

The spirits and advantages of the present invention can be better understood through the following detailed description of the present invention and the attached drawings.

### BRIEF DESCRIPTION OF THE DRAWINGS

The related drawings in connection with the detailed description of the present invention to be made later are described briefly as follows, in which:

FIGS. 1A and 1B are schematic diagrams of a wire data protection system according the embodiment of the present invention;

FIG. 2 is a schematic diagram of the wireless data protection system according the embodiment of the present invention;

FIG. 3 is a schematic diagram of the processor built in the data processing device according the embodiment of the present invention;

FIG. 4 is a schematic diagram of the processor attached outside the data processing device according the embodiment of the present invention;

FIG. 5 is a schematic diagram of the data protection system used for accessing the removable storage medium;

FIG. 6 is a schematic diagram of the ordinary data according the embodiment of the present invention;

FIGS. 7A and 7B are schematic diagrams of the encryption operation according the embodiment of the present invention; and

FIG. 8 is a schematic diagram of the scrambling arrangement according to embodiment of the present invention.

### DETAILED DESCRIPTION OF THE PREFERRED EMBODIMENT

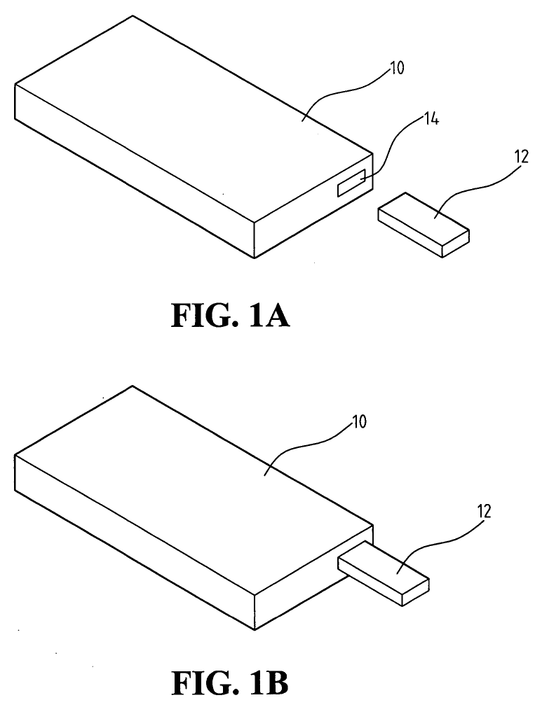

With reference to the drawings, and in particular to FIGS. 1A and 1B, a data protection system in accordance with the present invention comprises a data processing device 10 and a decryption element 12. The data processing device 10 stores protected data that have been processed by the protection code. The decryption element 12 stores the releasing code corresponding to the protection code by means of the memory unit, or the decryption element 12 itself is merely a magnetic diskette storing the releasing code, and the releasing code can be read by the disk drive of the computer main frame. Namely, if the data processing device 10 can be compared to the lock of the door, then the decryption element 12 can be compared to the key that is used to open the lock of the door.

The data storage medium, which can be accessed by the data processing device 10, can be classified roughly into the categories of optics, magnetic powder, and semiconductor. Taking for an example, the data storage medium of the readable optical category can be CD drive (including the burning machine); and the data storage medium of the readable magnetic powder category are hard disk drive, floppy disk drive, ZIP disk drive, JAZ disk drive, and magnetic tape device and the like; and the data storage medium of the readable semiconductor category is the flash memory reader/writer.

The above-mentioned data storage device 10 can further be classified into two categories of removable and un-removable based on the fact that whether the data storage medium can easily be removed from the data processing device 10. The removable data storage medium can be CD disk, floppy disk, ZIP disk, and JAZ disk; while the un-removable data storage medium can be the disk pack in the hard disk drive. It should be noted that, no matter what kind of data storage medium it belongs, the data stored in the data storage medium are the protected data which have been processed by the protection code. The only difference is that the procedure by which the originally ordinary data are converted into the protected data through the protection code, can be carried out in the processor which is built-in or attached-outside of the data processing device 10; even for the case of data storage medium of CD disk, the data originally stored on the CD disk are converted into the protected data in advance by means of the protection code, before they are stored into the data processing device 10.

Briefly speaking, the data processing device 10 which plays the role of the lock of the door to protect the data in the data protection system of the present invention, can be “opened” by the decryption element 12 playing the role of the key (to release the protected data so that they can be accessed by the data processing device 10). When it is necessary to read out the protected data stored in the data processing device 10, the releasing code required for the opening process is provided to the data processing device 10 by the decryption element 12 via the communication channel used to transfer information between the decryption element 12 and the data processing device 10. On receiving the releasing code, the data processing device 10 will convert the protected data back into the ordinary data by means of the built-in or attached-outside processor.

The above-mentioned communication channel can be used for wire communication or wireless communication. As shown in FIG. 1A, data processing device 10 contains wire USB communication interface 14. Therefore, as shown in FIG. 1B, when the decryption element 12 is connected to the data processing device 10 via that interface corresponding to the communication interface 14, the data processing device 10 will read the releasing code in the key similar device (decryption device 12), so that the corresponding device (data processing device 10) will proceed to disable the data protection procedure, and as such the data stored in the data processing device 10 can be read successfully by the computer main frame.

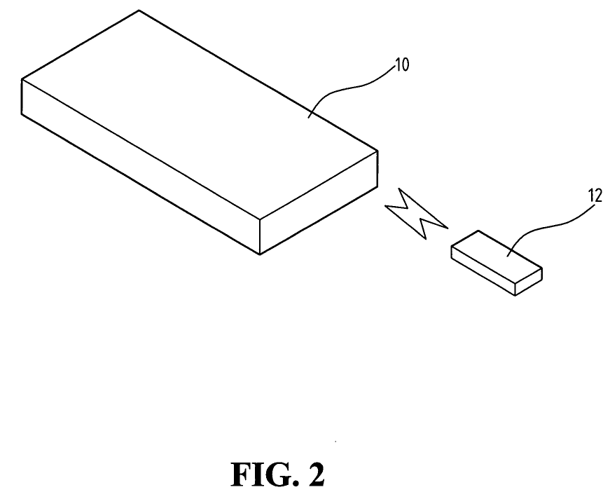

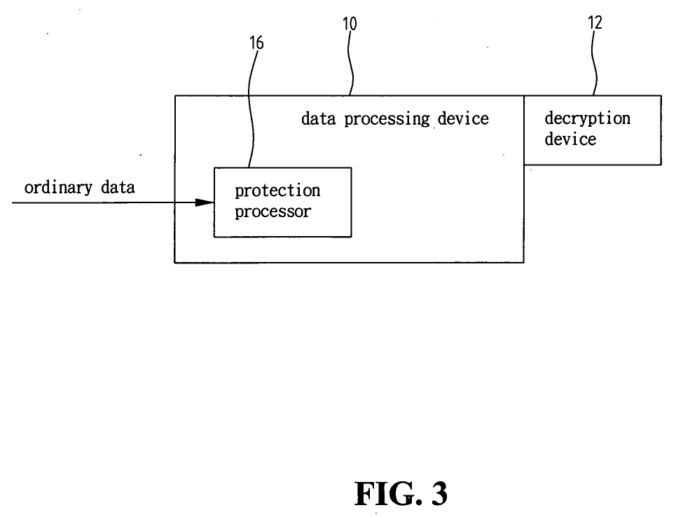

Referring now to FIG. 2, the communication channel between the data processing device 10 and the decryption element 12 can be established by means of one of the followings: infer red (IR) light, Bluetooth, radio frequency (RF) wave, laser and Microwave. As such in the similar manner, the releasing code contained in the decryption element 12 is provided to the data processing device 10 through this communication channel, so that the protected data can be processed and converted into the ordinary data by the data processing device 10 through the built-in or attached-outside processor. Also referring to FIG. 3, the processing procedure defined by the protection code can be executed by the protection processor 16 built in the data processing device 10. As such, for any ordinary data to be written into the data processing device 10, this ordinary data must first be processed by the built-in protection processor 16 of the data processing device 10 and be converted to the protected data in advance. Conversely, when the releasing code can be transmitted between the decryption element 12 and the data processing device 10, the protected data can be converted back to the ordinary data by the protection processor 16 through the releasing code.

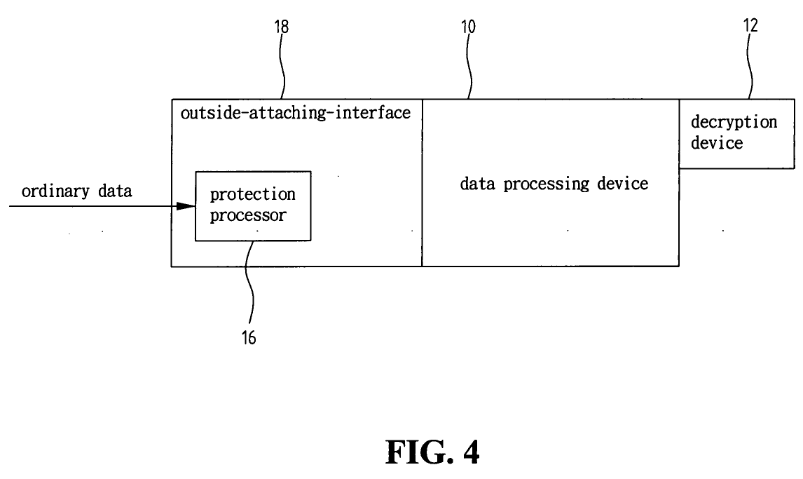

Referring to FIG. 4, the processing procedure defined by the protection code can be executed by the protection processor 16 in the outside attaching interface 18, and the conversion processing between the ordinary data and the protected data must be carried out through this protection processor 16.

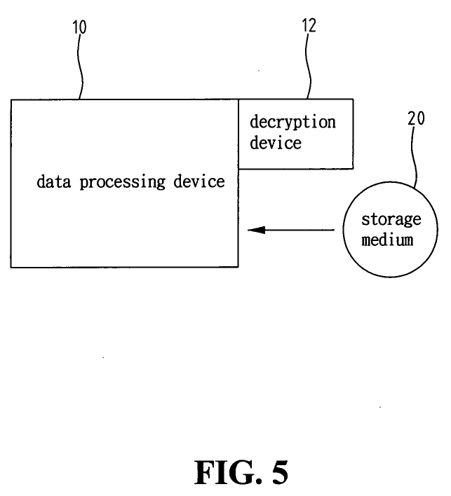

Referring to FIG. 5, the ordinary data stored on the CD disk are processed and converted into the protected data through the protection code in advance, before the CD disk which is used as the storage medium 20 is inserted into the data processing device 10. Therefore, after the storage medium 20 is inserted into the data processing device 10, the protected stored therein can be read by the data storage device 10. If subsequently the releasing code can be provided by the decryption element 12, then the protected data in the storage medium 20 can be converted back to the ordinary data by the data processing device 10 through the releasing code.

Therefore, supposing that the data processing device 10 is for example, such as the XBOX, PS2 game players, etc., then the developer of the game is able to convert the game programs of the originally ordinary data into the protected data through the protection code. When the user would like to execute the game programs, he must insert the decryption element 12 serving as the key of the game into the game player, so that the game player can successfully execute the game programs through the releasing code of the decryption element 12. As such, the developer of the game can execute the game programs by utilizing the simple duplication storage medium 20 through the low cost key of the game (decryption element 12), and thus can successfully thwart the illegal copying.

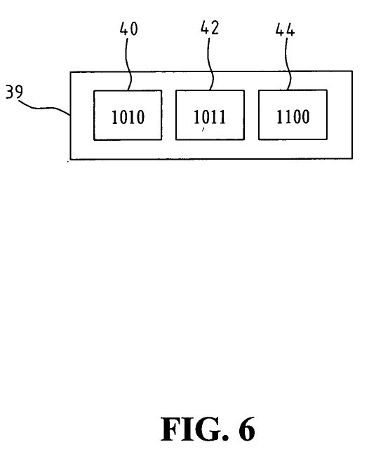

Referring to FIG. 6, the ordinary data 39 of the present invention is composed of, for example, bytes 40, 41, and 42. The binary codes contained in bytes 40, 41, and 42 are “1010”, “1011”, and “1100” respectively.

Since in the traditional data encryption processing, the purpose of data encryption is achieved by adding certain encrypting data in the header and tail of the ordinary data 39. However, by doing so, the size of the protected data would be enormously larger after this kind of processing. Therefore, the present invention makes use of the method recorded in the protection code, namely, by using byte as the unit, such that the ordinary data are converted into the protected data after the execution of the protection operation, so as to overcome the problem of the data becoming too large.

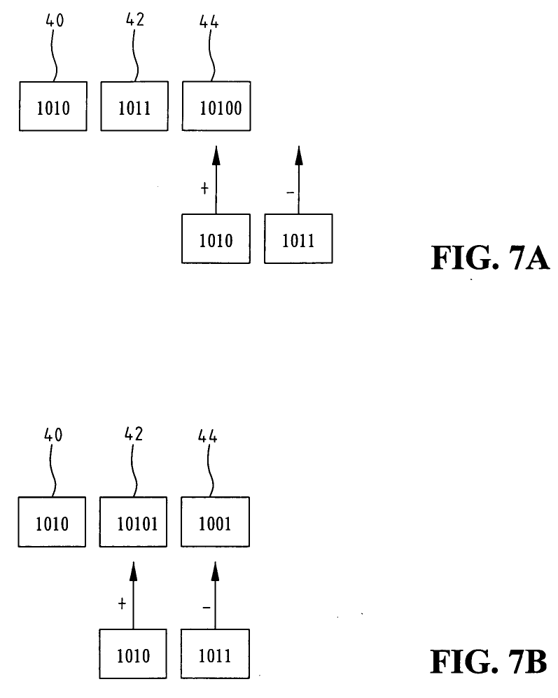

Referring now to FIGS. 7A and 7B, supposing that its operation rules is the basic operation rules of addition, subtraction, multiplication, and division, then the protection operation method of the present invention is based on these basic operation rules and the predetermined numeric values of “1010” and “1011”, converting the ordinary data to the protected data through the protection operations. The basic operation rule as shown in FIG. 7A is that: by first adding “1010” to any passing byte, and then subtract it by “1011”. And then in the next step, as shown in FIG. 7B, the value “10100” of byte 44 must be subtracted by “1011” to become “1011”, yet byte 42 must be added “1010” to become “10101”. However, if the reverse protection operation is carried out in the data processing device 10 through the releasing code, then the flow of operation will be entirely reversed, namely, by first subtracting any passing byte by “1011”, and then adding to it the value “1010”.

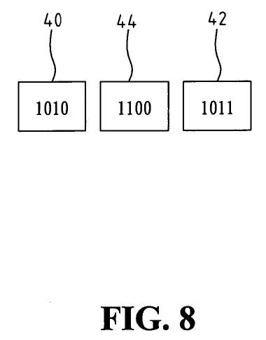

Referring to FIG. 8, FIG. 8 is the schematic diagram of the scrambled arrangement according to the embodiment of the present invention. And this indicates another way of performing the protection operation. It makes use of the scrambling rule to scramble the arrangement order of every byte of the ordinary data so as to become the protected data. As shown in FIG. 8, the order of byte 44 is exchanged with that of byte 42, and as such achieving the purpose of scrambling the arrangement order. Conversely, if the reverse protection operation needs to be carried out, then the arrangement order of byte 44 and byte 42 must be exchanged again.

Summing up the above, the present invention carries out the protection operation of encryption or scrambling in bytes, so that the protected data created by this operation will not occupy too much storage space, yet it can still likewise achieve the effect of data encryption.

The above detailed description of the preferred embodiment is intended to describe more clearly the characteristics and spirit of the present invention. However, the preferred embodiments disclosed above is not intended to be any restrictions to the scope of the present invention. Conversely, its purpose is to include the various changes and equivalent arrangements that are within the scope of the appended claims.

What is claimed is:

1. A data protection system, comprising:
a data processing device, the data processing device is used to access the protected data which have been processed by the protection code; and
a decryption element, the decryption is used to store the releasing code corresponding to the protection code;
wherein, when it is necessary to read the protected data, the protected data must first be converted back to the ordinary data in advance, by means of the releasing code provided by the decryption element.

2. The data protection system as claimed in claim 1, wherein a communication channel is disposed between the decryption element and said data processing device to communicate information, and the communication channel is used for providing the releasing code to the data processing device.

3. The data protection system as claimed in claim 2, wherein the communication channel is used for wireless communication, and the wireless communication can be one of the following: infer-red light, Bluetooth, radio-frequency wave, laser, and micro-wave.

4. The data protection system as claimed in claim 2, wherein the communication channel is used for wire communication, and the interface used in the wire communication is Universal System Bus (USB).

5. The data protection system as claimed in claim 1, wherein the data processing device can be one of the following: a CD drive, a hard disk drive, a floppy disk drive, a flash memory reader/writer, a ZIP disk drive, a JAZ disk drive, a magnetic tape device or the like.

6. The data protection system as claimed in claim 1, wherein the processing procedure defined by the protection code can be executed by a protection processor built in the data processing device, and any of the ordinary data to be written into the data processing device must first be processed and converted into the protected data by the protection processor.

7. The data protection system as claimed in claim 1, wherein the processing procedure defined by the protection code can be executed by a protection processor disposed in the outside-attaching-interface, and any of the ordinary data to be written into the data processing device must first be processed and converted into the protected data by the protection processor.

8. The data protection system as claimed in claim 1, wherein the data contained in the storage medium is the protected data processed in advance by the processing procedure defined by the protection code, and the protected data contained in the storage medium can be accessed by the data processing device.

9. The data protection system as claimed in claim 1, wherein the storage medium can be one of the following: a CD disk, a floppy disk, a ZIP disk, and a JAZ disk.

10. The data protection system as claimed in claim 1, wherein in the protection code is recorded how the ordinary data can be converted into the protected data in bytes through executing the protection operation.

11. The data protection system as claimed in claim 10, wherein the protection operation is a basic operation operating on every byte of the ordinary data based on a predetermined numeric value, so as to create the protected data, the basic operation includes the addition, the subtraction, the manipulation, and the division.

12. The data protection system as claimed in claim 10, wherein the protection operation is a scrambling operation used to scramble the arrangement order of every byte of the ordinary data with the scrambling rule to create the protected data.

13. The data protection system as claimed in claim 1, wherein in the releasing code is recorded how the protected data are converted into the ordinary data in bytes through executing the reverse protection operation.

14. The data protection system as claimed in claim 13, wherein the reverse protection operation is a basic operation reverse-operating on every byte of the protected data based on a predetermined numeric value, so as to create the ordinary data, the basic operation includes the addition, the subtraction, the manipulation, and the division.

15. The data protection system as claimed in claim 13, wherein the reverse protection operation is a scrambling operation used to reverse scramble the arrangement order of every byte of the protected data with the scrambling operation to create the ordinary data.
